(19) United States
(12) Patent Application Publication
(10) Pub. No.: US 2012/0057106 A1
(43) Pub. Date: Mar. 8, 2012

(54) POLARIZER AND LIQUID CRYSTAL DISPLAY

(75) Inventors: Kun Sik PARK, Daejeon (KR); Kyu Ha Baek, Daejeon (KR); Lee Mi Do, Daejeon (KR)

(73) Assignee: Electronics and Telecommunications Research Institute, Daejeon (KR)

(21) Appl. No.: 13/227,440

(22) Filed: Sep. 7, 2011

(30) Foreign Application Priority Data
Sep. 7, 2010 (KR) 10-2010-0087632
Aug. 29, 2011 (KR) 10-2011-0086469

(51) Int. Cl. G02F 1/1335

(52) U.S. Cl. 349/96

(57) ABSTRACT

Provided are a polarizer and a liquid crystal display (LCD) in which wire grid polarizers are formed on a thin film transistor substrate and a color filter substrate, respectively, so that it is possible to reduce fabrication cost and the number of processes and decrease the thickness of the LCD. An LCD includes a thin film transistor substrate, a color filter substrate opposite to the thin film transistor substrate, and a liquid crystal layer positioned between the thin film transistor substrate and the color filter substrate. In the LCD, wire grid polarizing patterns are formed on the thin film transistor substrate and the color filter substrate, respectively.

### CROSS-REFERENCES TO RELATED APPLICATIONS

The present application claims priority under 35 U.S.C 119(a) to Korean Application No. 10-2010-0087632, filed on Sep. 7, 2010 and Korean Application No. 10-2011-0086469, filed on Aug. 29, 2011, in the Korean Intellectual Property Office, which is incorporated herein by reference in its entirety set forth in full.

### BACKGROUND

Exemplary embodiments of the present invention relate to a liquid crystal display (LCD), and more particularly, to an LCD in which wire grid polarizers are formed on a thin film transistor substrate and a color filter substrate, respectively, so that it is possible to reduce fabrication cost and the number of processes and decrease the thickness of the LCD.

An LCD includes a thin film transistor substrate having pixel electrodes formed thereon, a color filter substrate having a common electrode formed thereon, and a liquid crystal layer interposed between these substrates. The LCD displays an image using a method in which liquid crystal molecules in the liquid crystal layer are rearranged through application of a voltage to the pixel and common electrodes, thereby controlling the amount of light transmitted to the liquid crystal layer.

Since an image is not formed through the self-luminescence of the LCD, light is incident onto the LCD from the outside so as to form an image. To this end, a backlight unit is mounted to a rear surface of the LCD so as to irradiate light onto the LCD.

Light emitted from the backlight unit is not incident onto an LCD panel as it is, but incident onto the LCD through a polarizer for providing a polarizing property. Therefore, the LCD displays an image using the optical anisotropy of the liquid crystal molecules and the polarizing property of the polarizer.

A method of attaching a polymer-type polarizer to an outside of an LCD panel is used as one of the existing methods of mounting a polarizer to an LCD. As a representative of the method, there is used a method of providing a polarizing property by chemically bonding iodine molecules in a certain direction on a polyvinyl alcohol (PVA) using a wet stretching method.

The polarizer has excellent polarization properties. However, since the polarizer is fabricated through a separate process fundamentally different from the process of fabricating the LCD, its price is expensive, and the cost of the LCD panel rises due to an increase of the number of processes including an attaching process and the like. Since an attaching polarizer is attached to the LCD panel using an adhesive, the thickness of the LCD panel is increased by the thickness of the adhesive and the thickness of the adhesive.

Unlike the polymer-type polarizer, a small-sized wire grid polarizer has been developed and applied to products such as a projector. The wire grid polarizer is fabricated by forming stripe patterns on a base substrate, and a metal such as aluminum (Al) is formed using a thin-film processing method. Here, the stripe patterns have a linewidth and interval smaller than wavelengths of red, green and blue included in the region of visible light recognized by human beings.

That is, wire grid polarizing patterns are formed to having a linewidth and interval of about 50 to 200 nm smaller than the region of the blue having the minimum optical wavelength in the visible light. If light is incident onto the wire grid polarizing pattern formed as described above from the backlight unit in the LCD, the light generally advances while vibrating in horizontal and vertical directions with respect to its advancing direction. Hence, only light incident in parallel with a space between the wire grid polarizing patterns passes through the wire grid polarizing pattern. Thus, the structure in which metal-based wire grid polarizing patterns are formed in such a manner is a wire grid polarizer.

If the wire grid polarizing patterns are formed using a metal such as aluminum (Al) with optically high reflexibility, light incident in a direction vertical to the space between the wire grid polarizing patterns from the backlight unit does not pass through the space between the wire grid polarizing patterns but is reflected and again incident onto the backlight unit.

Thus, if a phase transition layer, e.g., an anti-reflective layer, having a refractive index different from that of the wire grid polarizer is formed beneath the wire grid polarizer, the phase of light is changed in the phase transition layer and again incident onto the wire grid polarizer, so that an additional polarization occurs. The optical recycle described above is continuously generated, and accordingly, the wire grid polarizer has the effect of a dual brightness enhancement film (DBEF) for improving polarization transmittance. Since the optical recycle is implemented not using an existing complicated DBEF but using an anti-reflective structure, it is possible to implement a low-priced polarizer with high polarization transmittance.

However, like the existing polymer-type polarizer, the wire grid polarizer is fabricated through a separate fabricating process and then attached to an outside of the LCD panel. Therefore, the wire grid polarizer is more expensive than the attaching polarizer in terms of cost and the number of processes. However, like the polymer-type polarizer, the wire grid polarizer is fabricated through a separate fabricating process and then attached to an outside of the LCD panel. Therefore, the wire grid polarizer is more expensive than the attaching polarizer in terms of cost and the number of processes.

The LCD requires pixel and common electrodes so as to apply a voltage to the liquid crystal layer. Since these electrodes require a high transmittance of light, a high-priced indium tin oxide (ITO), indium zinc oxide (IZO) or the like should be used as a transparent electrode.

Meanwhile, Korean Patent No. 10-0677062 has proposed a color filter substrate composed of color filter layers each having light polarizers with a transmission axis in a certain direction in the inside thereof. Thus, a polarizer is not separately attached on the color filter substrate, thereby obtaining a lightweight and thin LCD panel.

However, in the Korean Patent No. 10-0677062, the color filter layer having a polarizing function has difficulty in selecting a material and a fabricating process. Further, the color filter layer still requires a polarizer on a thin film transistor substrate and pixel and common electrodes using high-priced ITO or IZO.

U.S. Patent No. 2008/0100781 A1 (Korean Patent No. 10-2008-0037324) has proposed a liquid crystal panel structure in which a separate polarizer is not attached on a thin film transistor substrate by forming wire grid polarizing patterns using a metal material of gate or data lines used as TFT interconnections of an LCD or using a combination of the gate and data lines.

There has been proposed a structure in which wire grid polarizing patterns are formed using a metal layer for black matrix, and a separate polarizer is not separately attached on a color filter substrate, so that it is possible to reduce the number of processes and fabricate a lightweight and thin liquid crystal panel.

However, in the U.S. Patent No. 2008/0100781 A1 (Korean Patent No. 10-2008-0037324), the liquid crystal panel structure still requires pixel and common electrodes using high-priced ITO or IZO.

### SUMMARY

An embodiment of the present invention relates to an LCD in which wire grid polarizers are formed on a thin film transistor substrate and a color filter substrate, respectively, so that it is possible to reduce fabrication cost and the number of processes and decrease the thickness of the LCD.

Another embodiment of the present invention relates to an LCD which enables a high-priced transparent electrode to be replaced with a low-priced metal pattern electrode.

In one embodiment, an LCD includes a thin film transistor substrate, a color filter substrate opposite to the thin film transistor substrate, and a liquid crystal layer positioned between the thin film transistor substrate and the color filter substrate. In the LCD, wire grid polarizing patterns are formed on the thin film transistor substrate and the color filter substrate, respectively.

The LCD may include first wire grid polarizing patterns having pixel electrodes formed on the thin film transistor substrate, and second wire grid polarizing patterns having common electrodes formed in a direction vertical to the first wire grid patterns on the color filter substrate.

The wire grid polarizing patterns may be formed on the same plane as the thin film transistor substrate and an element layer of the thin film transistor substrate.

The wire grid polarizing pattern may be at least one selected from the group consisting of aluminum (Al), copper (Cu), gold (Au), silver (Ag), chrome (Cr), tungsten (W), nickel (Ni), titanium (Ti), tantalum (Ta), molybdenum (Mo), neodymium (Nd), and carbon-based conductor (carbon nanotube or graphene), which is a conductive material through which visible light is not transmitted.

In another embodiment, an LCD includes a thin film transistor substrate comprising a first insulating substrate, a plurality of gate lines extended in one direction on the first insulating substrate, a plurality of data lines intersecting with the gate lines, pixel electrodes respectively formed in pixel regions defined by the gate and data lines, and thin film transistors respectively connected to the gate lines, data lines and the pixel electrodes, and a color filter substrate comprising a second insulating substrate, a black matrix formed corresponding to a region except the pixel regions of the first insulating substrate, and color filters and common electrodes formed corresponding to the respective pixel regions. In the LCD, at least one of wire grid polarizing patterns having the pixel electrodes formed with a predetermined linewidth and interval and wire grid polarizing patterns having the common electrodes formed with a predetermined linewidth and interval are formed on at least one of the thin film transistor substrate and the color filter substrate.

The wire grid polarizing patterns may be formed on the same plane as the pixel electrodes.

The wire grid polarizing patterns may be formed on the same plane as the data lines.

The wire grid polarizing patterns may be primarily formed with the gate lines on the same plane as the gate lines and then secondarily formed with the pixel electrodes on the same plane as the pixel electrodes.

The wire grid polarizing patterns may be primarily formed with the data lines on the same plane as the data lines and then secondarily formed with the pixel electrodes on the same plane as the pixel electrodes.

The wire grid polarizing patterns may be primarily formed with the gate lines on the same plane as the gate lines, secondarily formed with the data lines on the same plane as the data lines, and then tertiarily formed with the pixel electrodes on the same plane as the pixel electrodes.

The secondarily and tertiarily formed wire grid polarizing patterns may be formed in spaces between the primarily formed wire grid polarizing patterns, respectively.

The wire grid polarizing patterns may be formed on the same plane as the common electrodes.

The wire grid polarizing patterns may be primarily formed with lines of the black matrix on the same plane as the lines of the black matrix and then secondarily formed with the common electrodes on the same plane as the common electrodes.

The secondarily formed wire grid polarizing patterns may be formed in spaces between the primarily formed wire grid polarizing patterns, respectively.

In still another embodiment, an LCD includes upper and lower substrates respectively having element layers formed thereon, and a liquid crystal layer interposed between the upper and lower substrates. In the LCD, wire grid polarizing patterns formed a predetermined linewidth and interval are formed on at least one of the upper or lower substrates.

According to the present invention, wire grid polarizing patterns are formed on at least one of a thin film transistor substrate and a color filter substrate, so that it is possible to reduce the thickness of an LCD panel as compared with the conventional method of attaching a polarizer to the LCD panel.

Also, the wire grid polarizing patterns are simultaneously formed with structures of the thin film transistor substrate or the color filter substrate, so that it is possible to build the wire grid polarizing patterns in the LCD panel without increasing the number of mask processes.

Also, the structure of the LCD panel can be simplified by replacing an upper polarizer and an upper driving electrode with upper metal pattern electrodes and replacing a lower driving electrode and a lower polarizer with lower metal pattern electrodes.

Also, the LCD panel is composed of three layers, i.e., an upper pattern metal, a liquid crystal layer and a lower pattern metal, so that it is possible to simplify fabricating processes and reduce the thickness of the LCD panel. Also, the upper and lower driving electrodes are not formed of a high-priced transparent conductive material but formed of a metal material, so that it is possible to facilitate fabricating processes and decrease processing cost.

### BRIEF DESCRIPTION OF THE DRAWINGS

The above and other aspects, features and other advantages will be more clearly understood from the following detailed description taken in conjunction with the accompanying drawings, in which:

FIG. 1 is a schematic plan view of an LCD panel according to an embodiment of the present invention;

FIG. 2 is a sectional view taken along line I-I′ of the LCD panel in FIG. 1;

FIG. 3 is a view illustrating first wire grid polarizing patterns according to an embodiment of the present invention;

FIG. 4 is a view illustrating first wire grid polarizing patterns according to another embodiment of the present invention;

FIG. 5 is a view illustrating first wire grid polarizing patterns according to still another embodiment of the present invention; and

FIGS. 6 to 10 are schematic sectional views illustrating processes of fabricating an LCD according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

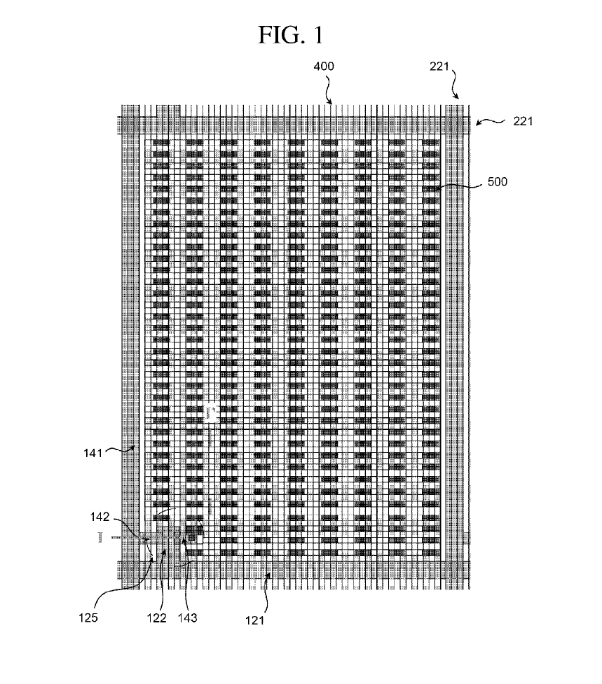

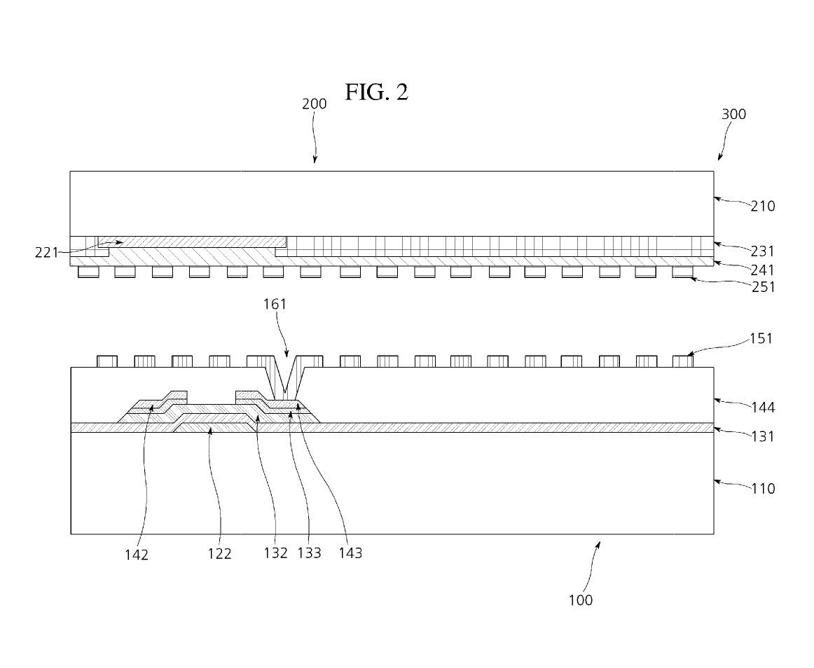

FIG. 1 is a schematic plan view of an LCD panel according to an embodiment of the present invention. FIG. 2 is a sectional view taken along line I-I′ of the LCD panel in FIG. 1.

Referring to FIGS. 1 and 2, the LCD panel 300 includes a thin film transistor substrate 100 and a color filter substrate 200, which are opposite to each other, and a liquid crystal layer (not shown) positioned between these substrates 100 and 200.

The LCD panel 300 also includes at least one of first wire grid polarizing patterns 400 formed with pixel electrodes 151 on the thin film transistor substrate 100, and second wire grid polarizing patterns 500 formed in a direction vertical to the first wire grid polarizing patterns 400 on the color filter substrate 200 and formed with common electrodes 251.

The thin film transistor substrate 100 includes a plurality of gate lines 121 extended in one direction on a first insulating substrate 110, a plurality of data lines 141 intersecting with the gate lines 121, the pixel electrodes 151 respectively formed in pixel regions defined by the gate lines 121 and the data lines 141, and thin film transistors 125 respectively connected to the gate lines 121, the data lines 141 and the pixel electrodes 151. The thin film transistor substrate 100 further includes the first wire grid polarizing patterns 400 formed in one direction using the pixel electrodes 151.

The gate lines 121 are generally extended in a lateral direction, and a portion of each of the gate lines 121 is protruded upward or downward to form a gate electrode 122. The data lines 141 are extended in one direction to be vertically intersected with the gate lines 121, and a portion of each of the data lines 141 is protruded to form a source electrode 142. When the data line 141 is formed, a drain electrode 143 is formed to be spaced apart from the source electrode 142 at a predetermined interval.

The gate line 121 may be formed of a metal selected from the group consisting of aluminum (Al), neodymium (Nd), silver (Ag), chrome (Cr), titanium (Ti), tantalum (Ta) and molybdenum, or an alloy thereof. The gate line 121 may be formed into not only a single-layered structure but also a multi-layered structure including a plurality of metal layers.

The data line 141, the source electrode 142 and the drain electrode 143 may also be formed of the metal described above, and may be formed into a multi-layered structure.

The thin film transistor 125 allows a pixel signal supplied to the data line to be charged in the pixel electrode 151 in response to a signal supplied to the gate line 121. Thus, the thin film transistor 125 includes the gate electrode 122 connected to the gate line 121, the source electrode 142 connected to the data line 141, the drain electrode 143 connected to the pixel electrode 151, a gate insulating layer 131 and an active layer 132, which are sequentially formed between the gate electrode 122 and the source and drain electrodes 142 and 143, and an ohmic contact layer 133 formed at least one portion of the active layer 132. The ohmic contact layer 133 may be formed on the active layer 132 except a channel portion.

A protection layer 144 is formed on the gate lines 121, data lines and the thin film transistors 125. The protection layer 144 may be formed of an inorganic material such as a silicon nitride or silicon oxide, or may be formed of a low dielectric organic insulating layer.

The pixel electrode 151 is formed on the substrate 110 in a pixel region defined by the gate and data lines 121 and 141. The pixel electrode 151 is connected to the drain electrode 143 through a contact hole 166. The first wire grid polarizing patterns 400 formed using the pixel electrodes 151 are formed on the entire surface of the thin film transistor substrate 100 or on pixel regions.

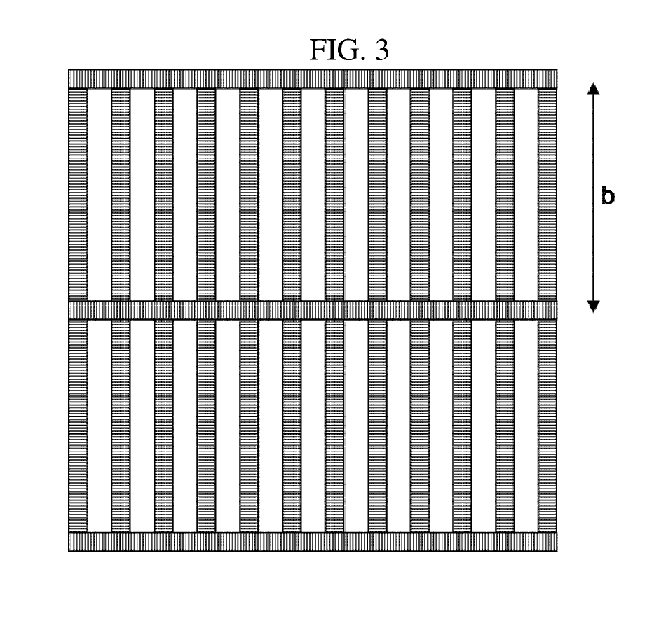

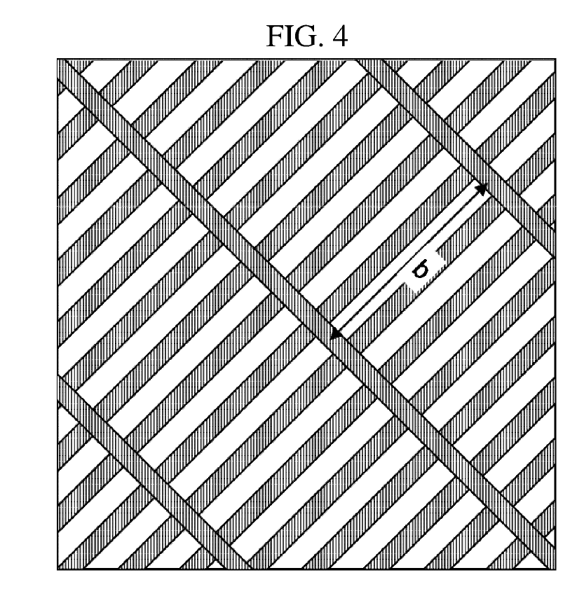

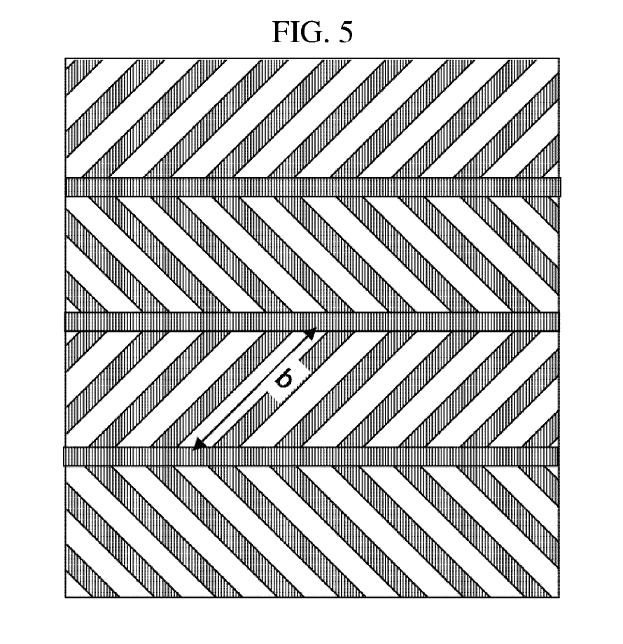

FIG. 3 is a view illustrating first wire grid polarizing patterns according to an embodiment of the present invention. FIG. 4 is a view illustrating first wire grid polarizing patterns according to another embodiment of the present invention. FIG. 5 is a view illustrating first wire grid polarizing patterns according to still another embodiment of the present invention.

Referring to FIGS. 3 to 5, the first wire grid polarizing patterns 400 may be formed in a vertical direction (FIG. 3), a horizontal direction (not shown) or a diagonal direction with a predetermined angle (FIG. 4) with respect to the gate lines 121. Alternatively, the first wire grid polarizing patterns 400 may be formed in combination of diagonal directions (FIG. 5) or combination of the vertical or horizontal direction and the diagonal direction (not shown) with respect to the gate lines 121.

The first wire grid polarizing patterns 400 formed using the pixel electrodes 151 are necessarily connected to one another at a predetermined interval ‘b’ so as to serve as the pixel electrodes 151 throughout the whole pixel regions. The first wire grid polarizing patterns 400 are preferably spaced apart from one another at an interval of minimum 1.3 μm or more so that polarized light is transmitted therethrough.

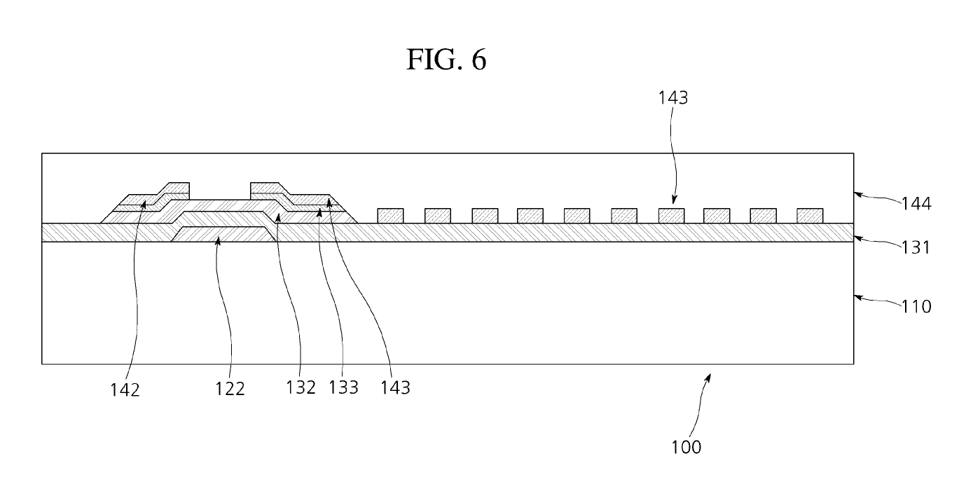

FIGS. 6 to 10 are schematic sectional views illustrating processes of fabricating an LCD according to an embodiment of the present invention.

Referring to FIG. 6, the first wire grid polarizing patterns 400 may be formed not using separate pixel electrodes but using the data lines 141, as illustrated in this figure.

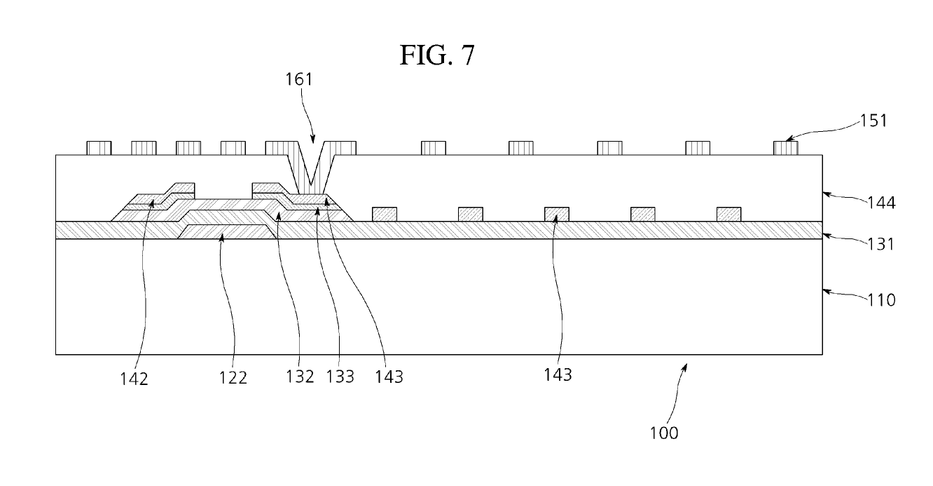

Referring to FIG. 7, the first wire grid polarizing patterns 400 may be primarily formed with the data lines 141 at the same time and then secondarily formed with the pixel electrodes 151 at the same time.

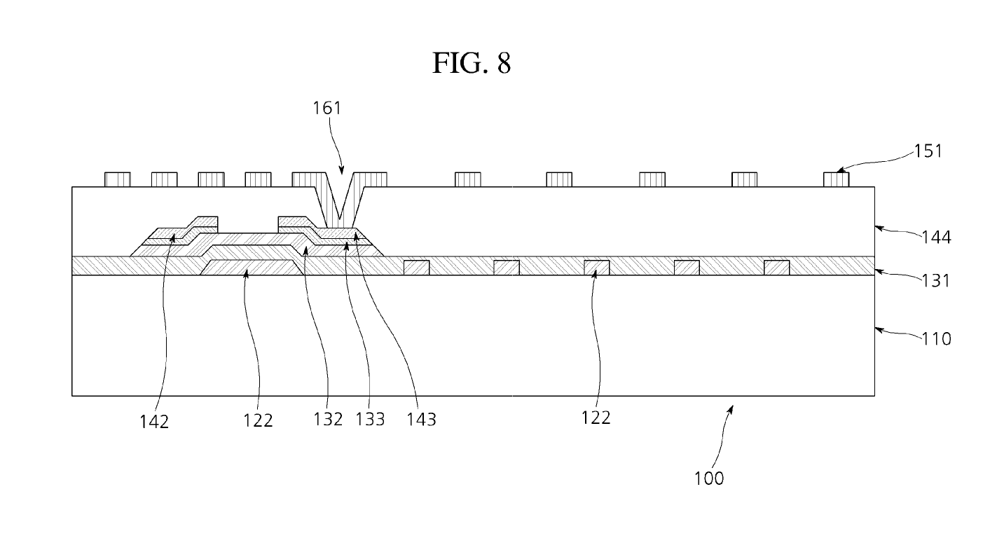

Referring to FIG. 8, the first wire grid polarizing patterns 400 may be primarily formed with the gate lines 121 at the same time and then secondarily formed with the pixel electrodes 151 at the same time.

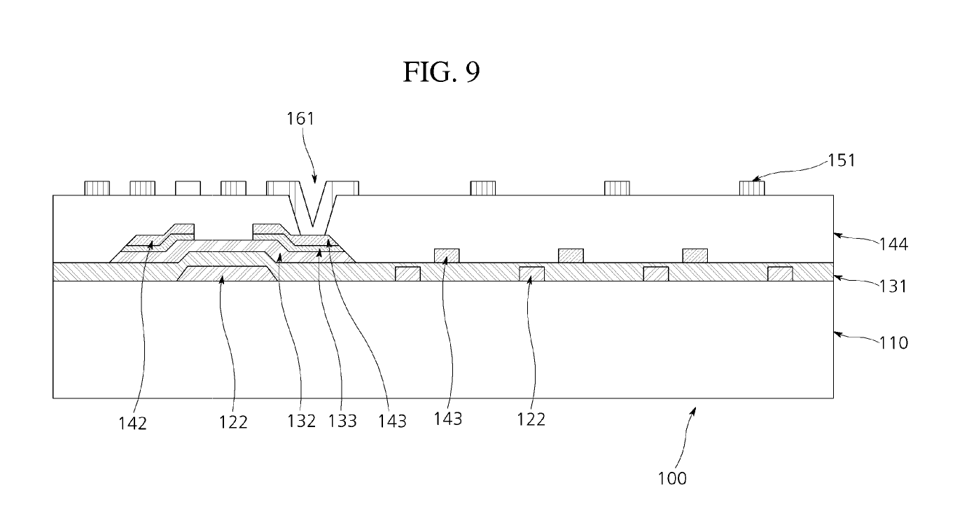

Referring to FIG. 9, the first wire grid polarizing patterns 400 may be primarily formed with the gate lines 121 at the same time, secondarily formed with the data lines 141 at the same time and then tertiarily formed with the pixel electrodes 151 at the same time.

In the two-step structure obtained by forming the first wire grid polarizing patterns throughout two times as illustrated in FIGS. 7 and 8, the secondarily formed first wire grid polarizing patterns are preferably positioned in spaces between the primarily formed first wire grid polarizing patterns, respectively.

In this case, the width of the spaces between the primarily formed first wire grid polarizing patterns is preferably greater than the linewidth of the secondarily formed first wire grid polarizing patterns so that light is easily transmitted.

That is, the secondarily formed first wire grid polarizing patterns are positioned in the respective spaces between the primarily formed first wire grid polarizing patterns by forming the interval between the primarily formed first wire grid polarizing patterns to be two or more times greater than a desired width and forming the linewidth of the secondarily formed first wire grid polarizing patterns to be identical to that of the primarily formed first wire grid polarizing patterns.

In the three-step structure obtained by forming the first wire grid polarizing patterns throughout three times as illustrated in FIG. 9, the secondarily formed first wire grid polarizing patterns and the tertiarily formed first wire grid polarizing patterns are preferably positioned in the respective spaces between the primarily formed first wire grid polarizing patterns.

That is, the interval between the primarily formed first wire grid polarizing patterns is formed to be three or more times greater than a desired width, and the secondarily and tertiarily formed first wire grid polarizing patterns are positioned between the primarily formed first wire grid polarizing patterns, respectively. The primarily, secondarily and tertiarily formed first wire grid polarizing patterns are not positioned on a straight line but maintain a certain interval.

Meanwhile, referring to FIGS. 1 and 2, the color filter substrate 200 includes a black matrix 221, a color filter 231, an overcoat layer 241 and common electrodes 251, which are formed on a second insulating substrate 210. The color filter substrate 200 further includes the second wire grid polarizing patterns 500 formed on the entire surface of the color filter substrate 200 or in regions respectively corresponding to the pixel regions of the thin film transistor substrate 100. The second wire grid polarizing patterns 500 are formed in a region corresponding to the region in which the first wire grid polarizing patterns 400 are formed. The second wire grid polarizing patterns 500 are preferably formed in a direction vertical to the first wire grid polarizing patterns 400.

The black matrix 221 is formed in a region except the pixel regions so as to prevent leakage of light through the region except the pixel regions and light interference between adjacent pixel regions. That is, the black matrix 221 has openings that respectively open regions in which the pixel electrodes 151 formed on the thin film transistor substrate 100.

The color filter 231 has red, green and blue color filters repeatedly formed between boundaries of the black matrix 221. The color filter 231 functions to provide a color to light that is irradiated from a light source and passes through the liquid crystal layer (not shown). The color filter 231 may be formed of a photosensitive organic material.

The overcoat layer 241 is formed on the color filter 231 and the black matrix 221 not covered with the color filter 231. The overcoat layer 241 functions to protect the color filter 231 while planarizing the color filter 231 and to insulate between upper and lower conductive layers. The overcoat layer 241 may be formed using an acrylic epoxy material.

The common electrodes 251 are formed on the overcoat layer 241. The common electrodes 251 apply a voltage to the liquid crystal layer (not shown) together with the pixel electrodes 151 on the thin film transistor substrate.

In the conventional LCD, the common electrode 251 is made of a transparent conductive material such as ITO or IZO. However, in the present invention, the common electrodes 251 are formed to be spaced apart from one another at a predetermined interval using aluminum (Al), copper (Cu), gold (Au), silver (Ag), chrome (Cr), tungsten (W), nickel (Ni), titanium (Ti), tantalum (Ta), molybdenum (Mo), neodymium (Nd), or carbon-based conductor (carbon nanotube or graphene), which is a conductive material through which visible light is not transmitted, so as to simultaneously serve as the second wire grid polarizing patterns 500. Thus, it is possible to simplify fabricating processes and reduce the thickness of the LCD without using the ITO or IZO that is a high-priced material.

The second wire grid polarizing patterns 500 may be formed on the entire surface of the color filter substrate 200 or in regions respectively corresponding to the pixel regions of the thin film transistor substrate 100, i.e., regions in which the color filter 231 is formed. The second wire grid polarizing patterns 500 are preferably formed in a direction vertical to the first wire grid polarizing patterns 400.

The second wire grid polarizing patterns 500 using the common electrodes 251 may be electrically connected to one another at end portions of the color filter substrate 200. Alternatively, like the first wire grid polarizing patterns 400, the second wire grid polarizing patterns 500 may be connected to one another at a predetermined interval. In this case, connecting interconnections are preferably spaced apart from one another at an interval of minimum 1.3 μm or more so that polarized light is transmitted therethrough.

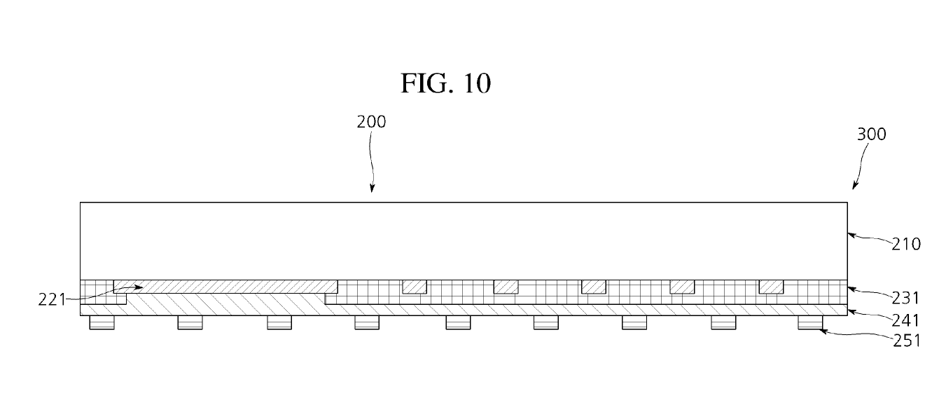

Referring to FIG. 10, the second wire grid polarizing patterns 500 may be primarily formed with the black matrix 221 at the same time and then secondarily formed with the common electrodes 251 at the same time. In a case where the second wire grid polarizing patterns 500 are formed throughout two times, the secondarily formed second wire grid polarizing patterns are preferably positioned in spaces between the primarily formed second wire grid polarizing patterns, respectively.

In this case, the width of the spaces between the primarily formed second wire grid polarizing patterns is preferably greater than the linewidth of the secondarily formed second wire grid polarizing patterns so that light is easily transmitted.

That is, the secondarily formed second wire grid polarizing patterns are positioned in the respective spaces between the primarily formed second wire grid polarizing patterns by forming the interval between the primarily formed second wire grid polarizing patterns to be two or more times greater than a desired width and forming the linewidth of the secondarily formed second wire grid polarizing patterns to be identical to that of the primarily formed second wire grid polarizing patterns.

Meanwhile, although it has been described above that the first wire grid polarizing patterns 400 are formed on the thin film transistor substrate 100 and the second wire grid polarizing patterns 600 are formed on the color filter substrate 200, the present invention is not limited thereto. That is, only any one of the first and second wire grid polarizing patterns 400 and 500 may be formed.

Light conversion layers may be further formed on bottom surfaces of the thin film transistor substrate 100 and the color filter substrate 200, respectively. Here, the light conversion layer allows light reflected from the wire grid polarizing patterns to be again incident onto the wire grid polarizing patterns. The light conversion layer may be formed by attaching a predetermined film or by depositing the predetermined film.

Meanwhile, in the aforementioned embodiments, the LCD has been described, in which the gate lines 121, the data lines 141 and the pixel electrodes 151 are formed on the thin film transistor substrate 100, and the black matrix 221, the color filter 231 and the common electrodes 251 are formed on the color filter substrate 200. However, the present invention is not limited thereto and may be applied to various liquid crystal cell structures and pixel structures. For example, in a case where the black matrix 221 is formed on the thin film transistor substrate 100, the present invention is applied to the fabrication of all LCD panels including a case where the common electrodes 251 are formed on the thin film transistor substrate 100.

As described above, according to the present invention, wire grid polarizing patterns are formed on at least one of a thin film transistor substrate and a color filter substrate, so that it is possible to reduce the thickness of an LCD panel as compared with the conventional method of attaching a polarizer to the LCD panel. Also, the wire grid polarizing patterns are simultaneously formed with structures of the thin film transistor substrate or the color filter substrate, so that it is possible to build the wire grid polarizing patterns in the LCD panel without increasing the number of mask processes.

Also, the structure of the LCD panel can be simplified by replacing an upper polarizer and an upper driving electrode with upper metal pattern electrodes and replacing a lower driving electrode and a lower polarizer with lower metal pattern electrodes. Also, the LCD panel is composed of three layers, i.e., an upper pattern metal, a liquid crystal layer and a lower pattern metal, so that it is possible to simplify fabricating processes and reduce the thickness of the LCD panel. Also, the upper and lower driving electrodes are not formed of a high-priced transparent conductive material but formed of a metal material, so that it is possible to facilitate fabricating processes and decrease processing cost.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A liquid crystal display (LCD), comprising:
a thin film transistor substrate;
a color filter substrate opposite to the thin film transistor substrate; and
a liquid crystal layer positioned between the thin film transistor substrate and the color filter substrate,
wherein wire grid polarizing patterns are formed on the thin film transistor substrate and the color filter substrate, respectively.

2. The LCD of claim 1, wherein the wire grid polarizing patterns comprises:
first wire grid polarizing patterns having pixel electrodes formed on the thin film transistor substrate; and
second wire grid polarizing patterns having common electrodes formed in a direction vertical to the first wire grid patterns on the color filter substrate.

3. The LCD of claim 1, wherein the wire grid polarizing patterns are formed on the same plane as the thin film transistor substrate and an element layer of the thin film transistor substrate.

4. The LCD of claim 1, wherein the wire grid polarizing pattern is at least one selected from the group consisting of aluminum (Al), copper (Cu), gold (Au), silver (Ag), chrome (Cr), tungsten (W), nickel (Ni), titanium (Ti), tantalum (Ta), molybdenum (Mo), neodymium (Nd), and carbon-based conductor (carbon nanotube or graphene), which is a conductive material through which visible light is not transmitted.

5. An LCD comprising:
a thin film transistor substrate comprising a first insulating substrate, a plurality of gate lines extended in one direction on the first insulating substrate, a plurality of data lines intersecting with the gate lines, pixel electrodes respectively formed in pixel regions defined by the gate and data lines, and thin film transistors respectively connected to the gate lines, data lines and the pixel electrodes; and
a color filter substrate comprising a second insulating substrate, a black matrix formed corresponding to a region except the pixel regions of the first insulating substrate, and color filters and common electrodes formed corresponding to the respective pixel regions,
wherein at least one of wire grid polarizing patterns having the pixel electrodes formed with a predetermined line width and interval and wire grid polarizing patterns having the common electrodes formed with a predetermined linewidth and interval are formed on at least one of the thin film transistor substrate and the color filter substrate.

6. The LCD of claim 5, wherein the wire grid polarizing patterns are formed on the same plane as the pixel electrodes.

7. The LCD of claim 5, wherein the wire grid polarizing patterns are formed on the same plane as the data lines.

8. The LCD of claim 5, wherein the wire grid polarizing patterns are primarily formed with the gate lines on the same plane as the gate lines and then secondarily formed with the pixel electrodes on the same plane as the pixel electrodes.

9. The LCD of claim 5, wherein the wire grid polarizing patterns are primarily formed with the data lines on the same plane as the data lines and then secondarily formed with the pixel electrodes on the same plane as the pixel electrodes.

10. The LCD of claim 5, wherein the wire grid polarizing patterns are primarily formed with the gate lines on the same plane as the gate lines, secondarily formed with the data lines on the same plane as the data lines, and then tertiarily formed with the pixel electrodes on the same plane as the pixel electrodes.

11. The LCD of claim 10, wherein the secondarily and tertiarily formed wire grid polarizing patterns are formed in spaces between the primarily formed wire grid polarizing patterns, respectively.

12. The LCD of claim 5, wherein the wire grid polarizing patterns are formed on the same plane as the common electrodes.

13. The LCD of claim 5, wherein the wire grid polarizing patterns are primarily formed with lines of the black matrix on the same plane as the lines of the black matrix and then secondarily formed with the common electrodes on the same plane as the common electrodes.

14. The LCD of claim 13, wherein the secondarily formed wire grid polarizing patterns are formed in spaces between the primarily formed wire grid polarizing patterns, respectively.

15. An LCD comprising:
upper and lower substrates respectively having element layers formed thereon; and
a liquid crystal layer interposed between the upper and lower substrates,
wherein wire grid polarizing patterns formed a predetermined line width and interval are formed on at least one of the upper or lower substrates.
